(19) United States
(12) Patent Application Publication
(10) Pub. No.: US 2016/0184938 A1
(43) Pub. Date: Jun. 30, 2016

(54) CORED SOLDER WIRE WITH ROSIN FLUX AND THERMOSET MATERIAL

(71) Applicant: STMICROELECTRONICS PTE LTD, Singapore (SG)

(72) Inventors: Yonggang JIN, Singapore (SG); Yun LIU, Singapore (SG)

(21) Appl. No.: 14/586,678

(22) Filed: Dec. 30, 2014

(51) Int. Cl. B23K 35/36; B23K 35/02

(52) U.S. Cl. CPC B23K 35/3618; B23K 35/0227

(57) ABSTRACT

The present disclosure is directed to a solder wire that includes a core having both a rosin flux and a thermoset material. The solder wire being configured to provide an oxide removing rosin flux to an electrical component, a solder alloy to the electrical component, and a protective layer to the solder alloy in a single soldering step.

### BACKGROUND

1. Technical Field

The present disclosure is directed to a solder wire having a core that includes rosin flux and thermoset material, the core being surrounded by a solder alloy.

2. Description of the Related Art

Solder has long been used in the mechanical and electrical fields to bind components together. For example, in U.S. Pat. No. 4,187,348, an automotive solder is described that is a thermosetting paste having imidazole cured epoxy-polysulfide rubber. The paste is applied to joints between sheet metal pieces using caulking cartridges, by spreading with a trowel, or other suitable methods. U.S. Pat. No. 4,187,348 also describes and epoxy-based body solder that is compatible with standard automotive paint. The epoxy-based solder is configured to withstand exposure to heat, cold, and other outdoor elements.

Solder is also used in semiconductor chip manufacturing to bond small conductive components together, allowing the components to transmit electrical signals. One example of a solder used in chip manufacturing is described in U.S. Pat. No. 6,402,013, which includes a flux. The flux is generally used to clean soldered joints, prevent oxidation of metal, and to lower surface tension of molten solder to improve wettability. The flux in U.S. Pat. No. 6,402,013 also includes a thermosetting epoxy that can be utilized for securing components. The flux includes a thermosetting resin added to a rosin flux that is then mixed with a solder powder to form a solder paste. The solder paste is applied to an area where a first component is to be joined with a second component. The solder paste is placed by printing or with a dispenser. Once the solder paste is in place, the second component is placed in the area and a reflow is performed to bond the first and second component. During the reflow, the solder paste joins the components and the thermosetting resin joins the components.

In U.S. Pat. No. 7,604,154, a thermosetting flux is provided that is suitable for solder bonding of a semiconductor element and an electronic component. The thermosetting flux is mixed with a solder paste, an epoxy resin, a hardening agent, and a rosin derivative having the flux as an indispensable component. The flux functions as an adhesive while being hardened at the time of soldering so that an element or a part can firmly be fixed in place. The solder paste is formed by kneading the flux and a non-lead type solder alloy powder.

### BRIEF SUMMARY

The present disclosure is directed to a solder wire that includes a core of thermosetting resin and rosin flux.

One embodiment of the present disclosure is directed to a length of solder wire that includes an exterior solder layer and an interior layer having rosin flux and thermoset material. The exterior layer is a solder alloy. The rosin flux may be surrounded by the thermoset material and the thermoset material is surrounded by the exterior layer. The rosin flux may be adjacent to the thermoset material such that the exterior layer completely surrounds the rosin flux and the thermoset material. The rosin flux and the thermoset material may be blended together and surrounded by the exterior layer.

In another embodiment, a device includes a length of wire having an exterior surface and an internal core, where the wire includes a fusible metal alloy that forms the exterior surface, a rosin flux material that is part of the internal core, and a thermoset material that is part of the internal core, the fusible metal alloy being position around the rosin flux material and the thermoset material. The fusible metal alloy completely surrounds sides of the rosin flux material and the thermoset material. The rosin flux and the thermoset material may be distinct portions of the internal core. The rosin flux material may be surrounded by the thermoset material and sides of the thermoset material may surrounded by the fusible metal alloy.

The interior core may include a plurality of separate material portions, a first one of the material portions being the thermoset material and a second one of the material portions being the rosin flux material. The internal core may a blend of the rosin flux and the thermoset material.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings.

FIG. 1 is a spool of solder wire;

FIGS. 2A-2C are different embodiments of a cored solder wire formed in accordance with the present invention;

FIG. 3 is a perspective view of a camera module;

FIG. 4 is a cross-sectional view of the camera module of FIG. 3;

FIG. 5 is a laser soldering tool adjacent to a camera module; and

FIG. 6 is a metal pad coupled to a metal pin with a cored solder wire formed in accordance with the present disclosure.

### DETAILED DESCRIPTION

In the following description, certain specific details are set forth in order to provide a thorough understanding of various embodiments of the disclosure. However, one skilled in the art will understand that the disclosure may be practiced without these specific details. In some instances, well-known structures associated with semiconductor manufacturing and camera module manufacturing have not been described in detail to avoid obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the drawings, identical reference numbers identify similar features or elements. The size and relative positions of features in the drawings are not necessarily drawn to scale.

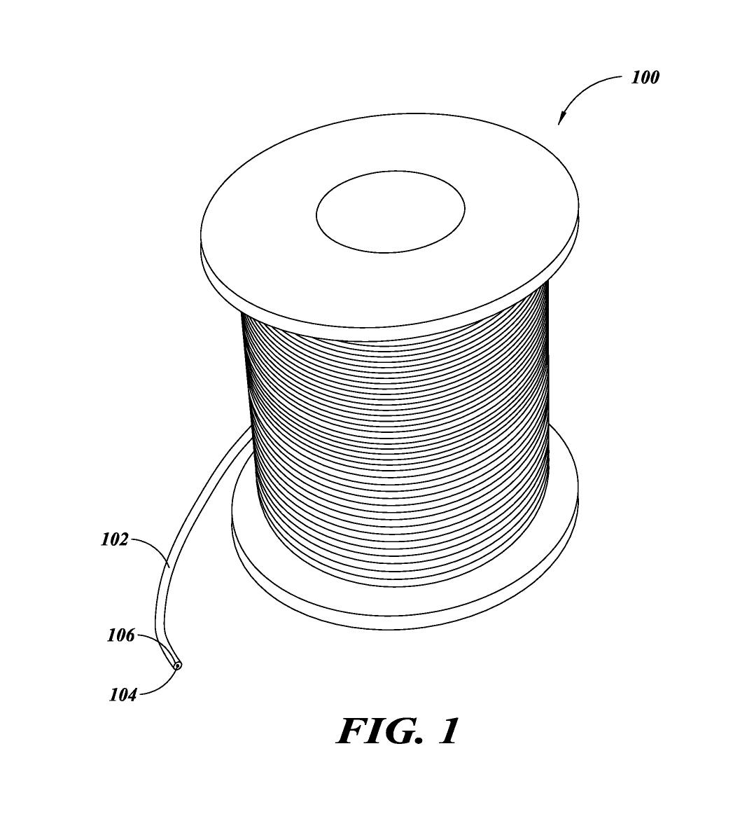

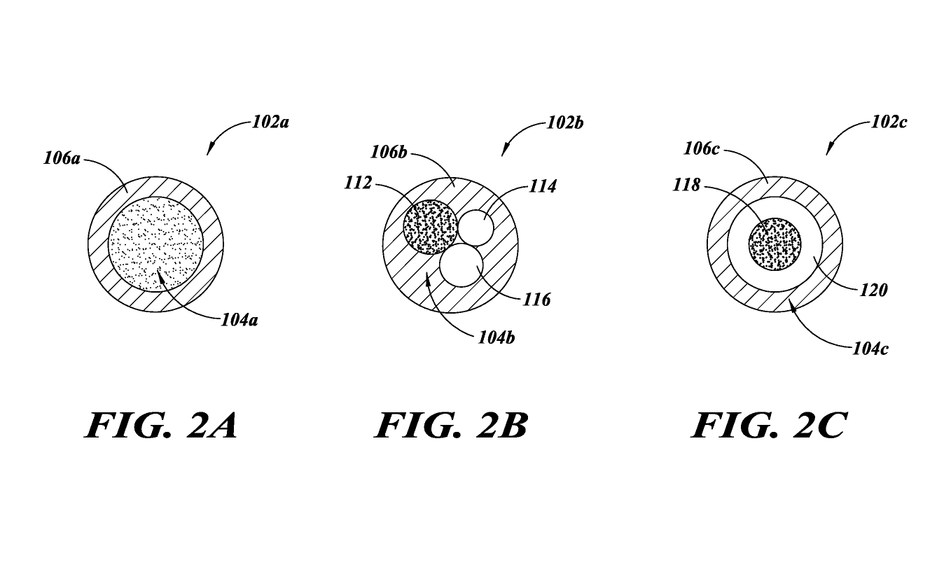

FIG. 1 is a spool 100 of cored solder wire 102 formed in accordance with an embodiment of the present disclosure. The cored solder wire 102 is a single elongated length of material that includes an interior core 104 surrounded by an exterior layer 106. The interior core 104 includes a thermoset epoxy and a rosin flux, see FIGS. 2A-2C. The exterior layer 106 is a solder material or a solder alloy. The interior core 104 may be one or more continuous length of material embedded lengthwise within the exterior layer 106.

The cored solder wire 102 can be utilized in electrical and electronics manufacturing, including semiconductor chip manufacturing and assembly of electronic devices, such as camera modules. As the exterior layer 106 melts during assembly, the interior core is released and the flux and thermosetting resin are released. The cored solder wire 102 can be formed into a range of thicknesses for use in different contexts.

FIGS. 2A-2C are cross-sectional views of different embodiments of the cored solder wire 102a, 102b, 102c. FIG. 2A is an embodiment that includes the exterior layer 106a that surrounds a single blended interior core 104a. In particular, the interior core 104a includes a combination of rosin flux and thermoset epoxy blended or mixed together to form a single elongated component. For example, the solder alloy of the exterior layer 106a may be formed as an elongated tube having a lumen. The lumen may then be filled with the blended rosin flux and thermoset epoxy to form the interior core 104a.

FIG. 2B is an embodiment that includes an exterior 106b and a plurality of interior cores, 112, 114, 116. Each of the interior cores is a distinct material from the other interior cores. For example, a first core 112 is a thermoset material and a second core 114 is a rosin flux. There may or may not be additional cores, such as a third core 116. In this illustrated embodiment, the third core 116 is also rosin flux. The third core or additional cores could include other materials beneficial to the soldering process, such as a hardening agent or a reducing agent.

The first core 112 has a larger diameter than the second and third cores 114, 116. Depending on the use of the cored solder wire, a ratio of the diameters can be adjusted to include more of one material than another. In this embodiment, the first, second, and third cores are abutting, however, it is possible that portions of the solder alloy will separate the cores from each other.

FIG. 2C is an embodiment of the cored solder wire 102c that includes a first core 118 that is enclosed within a second core 120, which is enclosed within the exterior layer 106c. In one embodiment, the first core 118 is the thermoset material and the second core 120 is the rosin flux. In other embodiments, the first core 118 may be the rosin flux and the second core 120 may be the thermoset material.

The solder alloy used for the exterior layer 106 is a heavier material than the thermoset material and the rosin flux. This solder based exterior layer 106 is a fusible metal alloy that can be heated and easily melted to join together conductive components. The solder alloy has a melting point that is below that of the components to allow for melting and coupling without damaging the components. For example, the solder alloy may melt in the range of 90 to 450° C., while a typical range of melting temperatures is between 180 and 190° C. The solder alloy will typically be a non-lead alloy and may be a zinc-aluminum-magnesium alloy, may be a zinc-aluminum-germanium alloy, a tin-copper alloy, a tin-silver alloy, tin-zinc alloy, a tin-bismuth alloy, or a zinc-aluminum-magnesium-tin alloy. The selection of the components of the alloy will depend on the use of the cored solder wire. Some considerations will be the likelihood of oxidation, the wettability of the solder alloy, and the brittleness. Other combinations of elements that can form the solder alloy are Sn, Ag, Cu, Zn, Bi, In, and Sb.

The thermoset material includes an epoxy resin, which may be bisphenol A epoxy resin, a bisphenol F epoxy resin, a phenol novolak epoxy resin, a cresol novolak epoxy resin, a naphthol novolak epoxy resin, a novolak epoxy resin of bisphenol A, a naphthalene diol epoxy resin, an alicyclic epoxy resin, an epoxy compound derived from tri or tetra(hydroxyphenyl)alkane, a bishydroxybiphenyl type epoxy resin, an epoxy compound of a phenol aralkyl resin and other similar components, or other suitable materials. These epoxy resins may be used alone or in combination to form a thermoset mixture. The mixture may include a curing agent, for example one selected from carboxylic acid anhydrides and amines.

The rosin flux can act as a reducing agent to reduce metal oxides at the points of contact to improve the electrical connection and mechanical strength, i.e., the rosin flux can return oxidized metals to their metallic state. Rosin flux is used for electronics, where the corrosiveness of an acid flux that releases vapors when solder is heated would risk damaging delicate circuitry. In an alternative embodiment, the rosin flux may be replaced by a water-soluble flux, which can be removed with deionized water and detergent.

Examples of electronic components on which this cored solder wire may be used include, but is not limited to, semiconductor packages such as flip chips, such as flip chips with a bump pitch of around 0.3 mm, components that have small electrodes for soldering and that are weak when joined only by soldering, such as land grid arrays, and resistors, coils, capacitors, transistors, and the other similar components that are attached to a printed circuit board.

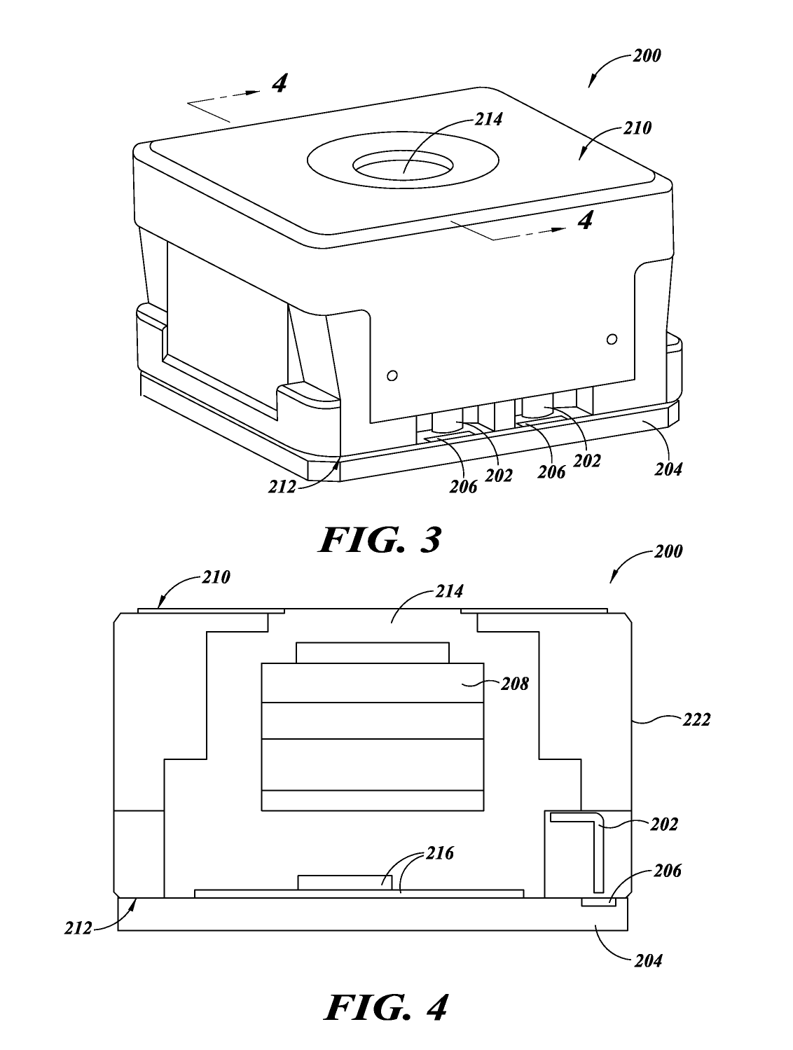

FIG. 3 is a perspective view of a camera module 200 that includes external facing pins 202 to be coupled to contact pads 206 on a substrate or printed circuit board 204. The camera module 200 is simplified in that not all of the features are presented, to focus on the pins 202 and the contact pads 206. Generally, the camera module 200 includes a lens structure 208 (see FIG. 4) adjacent to a first surface 210, where the substrate 204 is attached to a second surface 212 that is opposite to the first surface 210. An opening 214 in the first surface 210 is aligned with the lens structure 208.

FIG. 4 is a cross-sectional view of the camera module 200 through the lines 4-4 in FIG. 3. The lens structure 208 is aligned with the opening 214 and positioned over electronic circuitry 216 configured assist in image processing of the camera module. The pin 202 will be coupled to the contact pad 206 on the substrate 204. Various processes may be utilized.

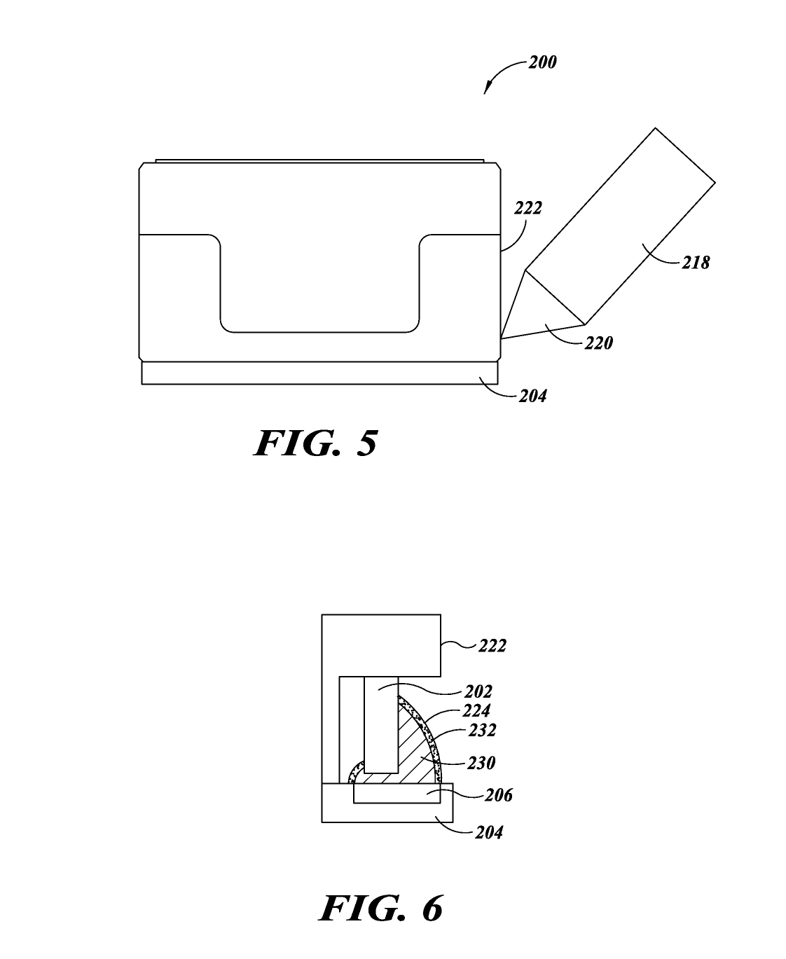

In FIG. 5, a laser soldering device 218 is positioned with a tip 220 adjacent to a side 222 of the camera module 200. The pin 202 to be soldered is recessed from the side 222 and the laser soldering device 218 is configured to be aimed at the pin 202 in the recessed part of the side 222. The laser soldering device 218 can automate the soldering process and allows for precise heating of the component to be soldered, such as the pin 202 and the contact pad 206.

The cored solder wire 102 having the exterior layer 106 of a solder alloy and an interior core 104 of a combination of rosin flux and thermoset epoxy according to embodiments of the present disclosure are configured to be utilized with the laser soldering device 218. The laser soldering device 218 heats up the pin, the contact pad, and melts the solder wire to form a joint 224, see FIG. 6. The rosin flux in the interior core 104 is used to hale remove any oxidation on the pin 202 or the contact pad 206. The pin and the contact are typically formed from a metal and thus the rosin flux removes any metal oxide formed on exposed surfaces of the pin and the contact pad. The contact pad 206 may be gold plated.

During the soldering process, the rosin flux evaporates while removing any oxide on the pin or contact pad. The rosin flux is quickly released with the application of heat, removes the metal oxide, and helps maintain viscosity. Most of the rosin flux evaporates. In one embodiment, the rosin flux can be heated to around 150 degrees Celsius. As the exterior layer 106 of the solder alloy melts, the solder alloy 230 settles downward, pushing the lighter thermoset material 232 outward, see FIG. 4. The thermoset material 232 becomes an exterior surface of the joint 224. A curing or annealing step will harden the thermoset material 232, creating an insulator to protect the joint from shocks, shorting, oxidizing, or other potential risks from exposure of the solder alloy to the environment. Once hardened a thermoset material cannot be reheated and melted to be shaped differently. This process avoids overflow of glue or insufficient coverage of glue used in previous processes to protect joints. Having the cored solder wire with both rosin flux and thermoset epoxy in the interior core of the wire eliminates the manufacturing step of applying the glue or other protective layer.

In one embodiment, the laser soldering device heats up the pad 206 and the pin 202 above the melting point of the exterior layer 106 of the solder wire 102, such as greater than 220 degrees Celsius. This may be a 2 millisecond heating process. A machine then moves the cored solder wire 102 into place to touch the pad and pin, melting the solder alloy and releasing the rosin flux and the thermoset epoxy.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a length of solder wire, the wire including:
an exterior solder layer;
an interior layer having rosin flux and thermoset material.

2. The device of claim 1 wherein the exterior layer is a solder alloy.

3. The device of claim 1 wherein the rosin flux is surrounded by the thermoset material and the thermoset material is surrounded by the exterior layer.

4. The device of claim 1 wherein the rosin flux is adjacent to the thermoset material, the exterior layer completely surrounding the rosin flux and the thermoset material.

5. The device of claim 1 wherein the rosin flux and the thermoset material are blended together and surrounded by the exterior layer.

6. A device, comprising:
a length of wire having an exterior surface and an internal core, the wire including:
a fusible metal alloy that forms the exterior surface;
a rosin flux material that is part of the internal core; and
a thermoset material that is part of the internal core, the fusible metal alloy being position around the rosin flux material and the thermoset material.

7. The device of claim 6 wherein the fusible metal alloy completely surrounds sides of the rosin flux material and the thermoset material.

8. The device of claim 6 wherein the rosin flux and the thermoset material are distinct portions of the internal core.

9. The device of claim 8 wherein sides of the rosin flux material are surrounded by the thermoset material and sides of the thermoset material are surrounded by the fusible metal alloy.

10. The device of claim 8 wherein the interior core includes a plurality of separate material portions, a first one of the material portions being the thermoset material and a second one of the material portions being the rosin flux material.

11. The device of claim 6 wherein the internal core is a blend of the rosin flux and the thermoset material.
